(19) United States
(12) Patent Application Publication
(10) Pub. No.: US 2021/0341128 A1
(43) Pub. Date: Nov. 4, 2021

(54) Control Drone Lighting Device

(71) Applicant: Elijah Abron, Silver Spring, MD (US)

(72) Inventor: Elijah Abron, Silver Spring, MD (US)

(73) Assignee: Teresa Elaine Byrd, Silver Spring, MD (US)

(21) Appl. No.: 17/302,134

(22) Filed: Apr. 25, 2021

(51) Int. Cl. F21S 43/14; B64C 39/02; F21S 43/15; F21S 41/153; F21S 45/43

(52) U.S. Cl. CPC F21S 43/14; B64C 39/024; F21S 43/15; F21Y 2115/10; F21S 45/43; B64C 2201/148; B64C 2201/042; F21S 41/153

(57) ABSTRACT

A control Spot lights and display drone, which has an auxiliary generator or battery to supply power for a combination of voltage, for lighting LED spot light and other auxiliary equipment and powering the drones, a wire tethering device that can move in conjunction with the drone; the drone lighting also can change colors to create a flashing lights effect (as a like police cars flashing lights). The remote LED spotlight controller is for changing colors of the LED lights for outside party lights or blinking lights; or just bright white lights, a voltage reducer that's piggyback off the power wires; a battery or a generator for supplying power to power the drone body internal and external components such as a display and lights; a mounting bracket for mount the LED spot lights; a LED spot lights mounting bracket that has at least two holes for mounting LED spot lights to bracket; a voltage reducer; whereby the allowing the drone or drones to fly for a longer period of time, also longer illumination and illustrating time in the air; also, the use of solar cells to aid in powering the drones;

### FIELD OF THE INVENTION

### 1. Field of the Invention

This invention relates to using LED spot lights and a tethering power source for powering the drone LED spot lights and the drone controls and other devices.

### 2. Description of Prior Art

The prior inventions don't support drones with auxiliary batteries that's under a continuous charging or having a generator for powering there drone, or any other devices such as the use of a bright lighting system for a work area at night or lighting system for playing sport at night in a remote area, that doesn't have electrical power lighting such as a light poles, or any kind lighting sources for a nighttime work or play event; however, none of today's manufacture or in users has used a combination of auxiliary batteries and a spot lights on a drones at night for working or play.

### SUMMARY OF THE INVENTION

The drone is control remotely and the auxiliary power to the drone is power from within with a battery or generator, and externally battery or generator with a tether auxiliary batteries to power drone and it's component's and supply the external LED spotlights with external power from the tether power wires, from the batteries that are attached on the ground, to the drone that's in the air, has an remote controller 88 for controlling flight and position of the drone in the air, the drone receives almost all of its power functions, from the auxiliary battery or generator that is tether to the drone that's on the ground, that extend the drone fighting time from minutes to hours of flight time, this increase because from minutes to hours from the uses of the auxiliary battery or generator that is sending power to the drone and it's components, from two wires from the battery or generator. The LED spot lights and drone which have a combination of LED spot lights that are power from the tether 80 wires, the wires move independently as the drone moves upward, downward and side to side, maintaining power to the drone; the LED spotlights is design for nighttime work or play at nighttime or just get together such as back yard parties.

A device for exhibiting LED spotlight mounted on a drone, the drone having a body, at least one internal battery or generator from powering the drone component's, a voltage reducer and at least one or more spot lights; a battery or generator; a wireless receiver; an electronic speed controller; a flight controller 88; said lighting device for powering LED spotlight comprising:

the drone body having a small battery or generator powering internal component's within the body of the drone and an auxiliary power supply for powering spotlights and flight controls; the drone has an mounting plate with holes for hard wiring connection to the LED spotlight and voltage reducer that is connected to the 12 volts incoming power from the battery or generator that is on the ground; the LED spotlight mounting bracket having at least one or more holes for attaching lights to the drone body, the lighting mounts via screws or gluing or molding in mounts, the spotlight brackets and the voltage reducer, to allows the LED spotlight voltage reducer to send power to the drone controls via wires from battery or generator, the LED spotlights receives its power direct from the batteries on the ground, they are mounted on the mounting brackets on the drone body with the tether 80 wires attach to the drone; the mounted LED spotlights that's mounted on the bracket is power lines are moving independently with the drone, the LED spotlight creates a brilliant light.

The drone body can have multiple lighting mounts; each lighting mount can have at least one hole to mount auxiliary components on the drone voltage reducer. The LED spot lights mounting bracket can be plastic and can be made square rectangular or in a shape for mounting the LED spot lights. The drone is wire and wirelessly connected to a battery or generator for continuous flight or a ground control computing device, which is a computing device with wireless communication inputs and can direct the LED light strip display unit to be program or lights to activate.

the Voltage reducer is to reduce the voltage of the controlling components and motor of the drone and others components. the LED spot lights can be operated by the flight controller of the drone. The additional flight controller can be a smartphone, or a tablet.

A method of creating a persistence of vision display using a drone, an lighting device for presenting LED spotlight and a ground station computing device with a wireless communication system; said drone having a drone body, at least one drone; a Voltage reducer and at least one propeller blade; a battery or generator; a LED microcontroller; a wireless receiver; an electronic speed controller; a flight controller 88; said lighting device for LED spotlight comprising:

the drone body having lights mounts for the drone LED spot lights;

the drone body lighting mounts having an at least one LED spotlight and one Voltage reducer; the drone body lighting mounting can have at least one or more LED lights strips connections ports for the display unit or units;

A LED spot light mounting bracket has one or more holes for mounting LED spotlights and is attached to the drone body mounts via screws, glue or welded and the Remote switch for LED spotlight and voltage reducer to activate power to the drone and its components, whereby allows the LED spotlight to have 12 volts and the voltage reducer to have 3.7 volts or higher, the LED spot lights mounting brackets are mounted on the side of the drone body, one on the left and one on the right of the drone an a center mounting bracket axis of the drone body that can be used as a center lifting 25 of optional lighting devices, that can have movement with the drone, comprising the following steps:

In the present invention the embodiments several aspects that can be used independently, although they are together as an optimize benefits. All of the advantages of the invention will be consideration of the detailed description, with reference to the appended drawings.

### BRIEF DESCRIPTION OF THE DRAWINGS

FIG. 1 shows a view of one embodiment of the invention, which shows an overview of the LED Spot lights on the drone.

FIGS. 1a shows one embodiment of the layout of components on the drone and the flight controller for controlling the drones from the ground.

FIGS. 2 shows one embodiment of the tethering batteries DC power to the drone or drones for powering drone or drones from the ground.

FIGS. 3 show tethering reel of one embodiment for feeding AC power to the drones or drones also showing the wiring connection for ground Communication to device or devices

FIG. 4 shows a diagram of the display system using LED light strips that are program from controller or other wireless communication devices.

### PARTS LIST

10 LED spot Lights; 60 LED light strip for display unit; 100 A Drone Body; Drone LED Display 60; LED spot lights mounting bracket 23; Under body hanging bracket; Flight Controller 88; Connection for other drones 135; 90 Drone Voltage reducer; Propeller 77; remote power switch; LED spotlight Voltage reducer 50 generator 55, Battery 60, Microcontroller; microcontroller computing device 65, Wireless Receiver Arduino 70, tablet 200 Unit for displaying Light;

### DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

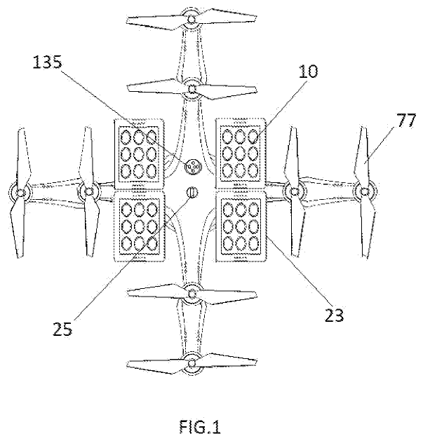

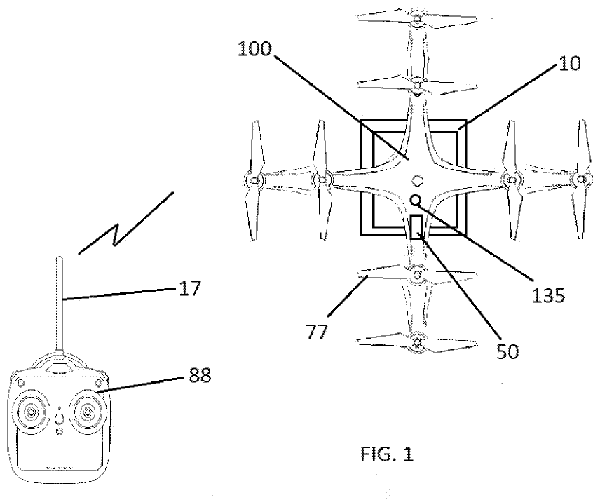

Referring now to FIGS. 1 and 1a Basic Drone Lighting device includes without limitation: a drone body or bracket 110; at least one drone Voltage reducer and at least one rotating blade or fan; a battery 60 or generator; a computing device or computing control device or flight controller 88; antenna 17; electronic speed controllers or sensors; stabilizers; gyroscope; altimeter; accelerometer and magnetometer; and a wireless receiver. The drone body 100 can have at least one or multiple lighting mounts, which each can have a drone Voltage reducer and propeller; the drone body and/or lighting mounts can also have lights or LED spot lights 10. Some of the electronic components or sensors can be combined into a computing device on the drone itself or be placed on different parts of the lighting device (LED bracket 110, drone lighting mounts or drone body). All of the electronics, LED spot lights, batteries on the drone or LED spot lights 10 mounting bracket 110 can be connected with wiring.

### Lighting Device Embodiment

One preferred embodiment of the invention is a wire feeding reel device10 that feeds power by wirer cables, that is connected from the battery 60 or generator 55 on the ground to the drone in the air, for powering lights and other components that are attach to the drone; a round shaped reel that supplies power to the drone electrical system for power from the battery 60 or generator 55 on the ground, this powering process also supplies power to the LED strip light display unit 60 that is connected to the drone for powering lights and other devices on the display unit from the reel powering system which moves independently and separately from the drone, that's being control by a remote device, The reel can also be programmed to react to the drone by increases or decreasing it's distance.

FIG. 1a Separate power voltage, one for powering drone inter component's and the other is for the spot lights allow the light mounting lighting device on the drone lighting. The invention employs programs for the display and to activate said lights and the drone components. RF is radio frequency or any other wireless communication format; laptop refers to any computing device, including Smart Phone, laptop, tablet 200, notebook or any other mobile or desktop computing device.

### Lighting or LED Spot Lights Mounting Brackets

The drone body can have multiple drones lighting mounts, including a drone body lighting mount and a drone body lighting mount. The and the drone lighting mounts can be connected to the lighting or LED bracket 110. The or drone lighting mounts can have at least one or more LED body Voltage reducers.

The LED spot lighting mounting bracket 23 has at least one LED spot lights that's mounted to the drone body 100, the lighting mounts also supports the connector 135 for multiples connecting drone's as well, LED spotlight Voltage reducer power can be daisy link, whereby allowing the remote Voltage reducer to supplying power to the other drone body 100 components for in depend and non in depended of movement of the drone. LED spot lights bracket are made of different colors and materials.

### Wireless Connection and Control

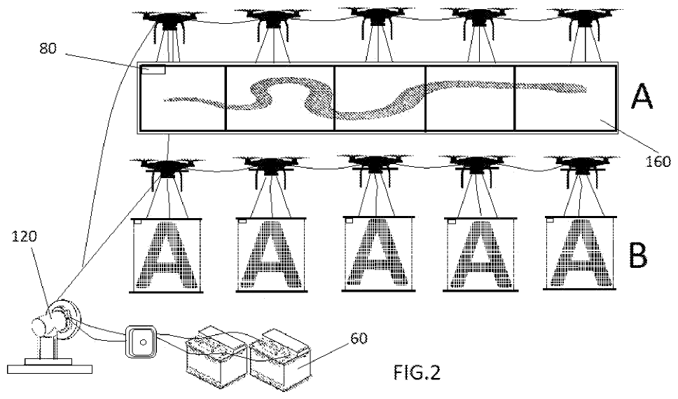

FIG. 2 A preferred embodiment, of the invention is that it has a wire and wireless controls output power not only for the drone's flying controls but voltage output for the drone's flight system and the LED spot lights, plus power for a Arduino 70 unit for controlling the LED lights strip 160 on the display unit, As show in FIG. 1 the Arduino 70 send a random bits of information to the LED strip lights to light up, in illustration A is a display box with light within the box, creating a pattern within the display such as number or different characters or illustration such as snake, trees, birds, names, planes in flight etc. the display unit is a hollow box with strips of LED light that are program to turn on to create images on a thin with sheet that illuminate the characters on the outer display sheet, On FIG. 1 illustration B shows LED lights strips 160 that are hanging from top to bottom that works that same as Illustration A just la lot brighter because there no covering sheet.

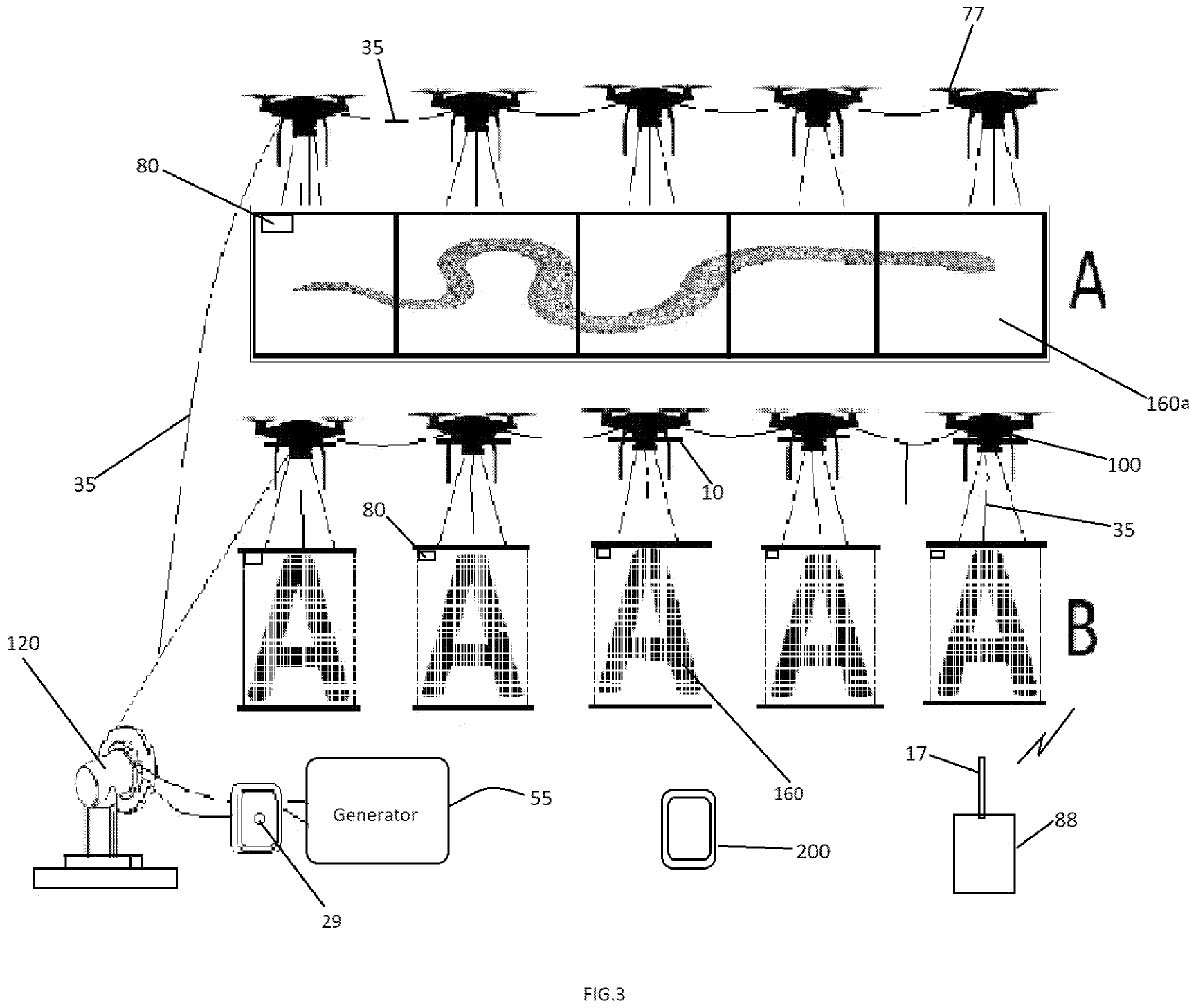

FIG. 3 The power supply line 35 that supplies power from the ground to the drone for the powering LED spot lights and other voltage as reducer are connected to the mounting bracket 23 that is now show on the drawing, on the drone is feeding wire independently to the drone, to at least one or more LED spot lights 10 that are mounted on the drone, the LED spot lights has a bright light that illuminate a large area of vision, and allow things to be more visitable in a dark unlit area, the battery 60 or generator 55 and be move along with the drone or it can be stationary in a relation with the drone and at least one LED spot lights or lights strip. For The display of light from the LED spot lights or LED light strip display unit, that are connected to the mounting bracket 23, that is mounted under the drone that is connected to a battery 60 or generator 55 that's mounted on the ground and connected to the drone in the air, creating visually image in the night sky.

The drone is wireless and wire connected to a flight controller and a power source, which is for power component's and the LED spot lights to activate, from a Remote switch 29 that control the power that feeding the drone lights and adding auxiliary power to the drone controls and drone LED spot lights and voltage reducer to activate, that moves the drone with the LED spot lights and to operate the flight controller of the drone. That communication with RF but can also include Bluetooth communications.

The battery 60 or generator 55 for continuous flight can also be a generator; the visual input can be a LED light strip for display units 60; and other type of electronic components;

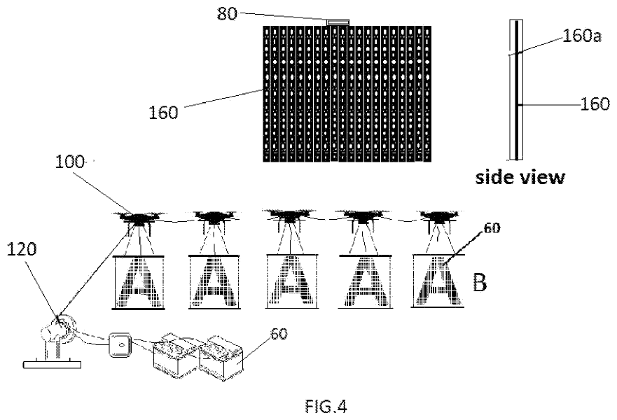

FIG. 4 the drone wires are connected to the battery or a generator 55 on the ground that is connected to a switch 29 for powering up the drone and it's controls and well as the LED spot lights, the wires are connected ground battery station with a switch 29, to turn on and off power to the LED spot lights and voltage reducer; that powers the LED spot lights and voltage reducer via. Tether wires to turn on or off the power to the lighting devices and other components that the battery 60 supply power to for powering the controls and movement of the drone propeller 77 and controls. and the LED spot lights are that independently power from the drone powering controls.

The drone is connected to the controller wireless control system; the drone is connected wireless when the controlling the unit for takeoff and landing, In the FIG.xx shows a connection unit that is connected to the drone and the lifting 25 hardware for display unit with several drones and a different program to communicated to the display CPU unit. . . on the display unit, that can have a running message or a prerecording program loaded into the Arduino 70 unit that's within the display or LED light strip for display units, that can be activated remotely from the ground from a tablet 200 or computer, the drone can be activation/deactivation of the LED spot lights, power and display unit that's on the drone, the LED spot lights 10 that's mounted on the bracket 110 that's mounted to the drone body 100.

In FIG. 1a, a controlling device on the ground as a remote unit, can be use the input information to the drone or it's component's to react to moments such as the height of the drone and side to side monuments, as a remote control position or having GPS positions to control the drone internal component's or it' internal programing; the wire connected ground battery 60 or generator 55 unit switch 29 can power the lights to turn/on off, the lighting device moves up and down and side to side, the display unit or light strip remain at one position.

In one of the embodiment, the LED spot lights are being cool by the propellers 77; and also there is a connector 135 that is mounted on the drone for connecting other drone for feeding power to the other devices, this tethering 80 connection elements interconnected by one or more connections, the device also serve as a powering connection, for several drone units, with this connection will turn on or off the power to the LED lights and power; or change position of the fighting area.

The lighting device also allows the human operator to change the drone position activate LED spot lights10 and devices plus the drone movement.

In FIG. 2 the movement of the drone and the lights can be independent of one another; the drone can remain stationary, but the lights and light structures can be moving and actuated. Since the light mounting ring or LED spot lights 10 mounting bracket 23 is at the furthest part of the periphery of the drone, the light mounting structure can block or cloak the drone lighting device from view.

This invention relates to remote or non-remote-control drone, which has LED spot lights 10 and LED light strip for display units for lighting at night, with software that can be remotely inputted into the display unit remotely to activate the display or LED light strip for display unit at night or dust dark sky.

The Visual display of lights can be defined as a visual image for an externed period of time; the display acts the same as a billboard sign for advertisement that produces the viewing of an pictures or design.

The drone propulsion system (motors, electronic speed controllers and propellers) are the drone technology, which move the UAV An unmanned aerial vehicle (UAV), commonly known as a drone, as an unmanned aircraft system (UAS), and also referred by several other names, is an aircraft without a human pilot aboard. into the air and to fly in any direction or hover. On a quadcopter, the motors and propellers 77 work in pairs with 2 or more motors/propellers 77 rotating clockwise (CW Propellers 77) and 2 or more motors rotating Counter Clockwise (CCW, Circular motion can occur in two possible directions; A clockwise (typically abbreviated as CW) motion is one that proceeds in the same direction as a clock's hands;

The invention herein involved, the intended that all of the subject matter of the above description that are shown with the accompanying drawings shall be interpreted merely as a demonstration of the illustrating of the inventive concept herein and shall not be construed as limiting the nature of the invention.

We claim:

1. A lighting and displays device, for use as a spotlights or display unit of a drone or drones; said drone having a drone body; at least one drone with voltage reducer unit; and at least one tethering auxiliary battery or generator for powering drone; a wireless receiver; an electronic controller; and a flight controller Remote controller; a switch or a remote for turning on lights and system component's, said lighting device for drone LED spotlight comprising: the drone body having a mount for mounting lights; the drone propellers act as a cooling device to keep LED lamps cool; the drone having a body lighting mounting bracket; having an hook connection mounted underneath the body of the drone left and right; a remote LED spotlight; a controller for changing colors of the LED spotlight for party lights or blinking lights or just bright white lights; a voltage reducer for powering drone or drones component's and for drone LED spot lights; the mounting bracket has at least one LED spot lights and is mount to the drone body; a remote switch for powering the LED spotlights and voltage reducer for reducing the voltage from 12 volts to 3.5 volts (or higher); the LED bright spot lights are mounted to the body underside of the drone facing down; and or side mounted facing outward, that are independently from the drone internal lights; from the top to the right, then down and then to the left, and back up to the top; the LED spotlight lighting for outdoor nighttime activity such as parties, sports or road construction; the light also has flashing lights effect; a tethering system that can maintain several drones at the same time; a small generator or batteries; another aspect of the invention is that solar cell can be added instead of LED spot lights for longer flight time as well.

2. The lighting device of claim 1, whereas there's the bright visible LED spot lights that is concentrated underneath the body of the drone or drones; having bright LED spot lights casting a bright visible white or color flashing lights that are visible at night and is controlled by a controller.

3. The lighting device of claim 1, whereas the drone body has a lighting connecting mounts with at least one Voltage reducer and at least one or more rotating blades.

4. The lighting device of claim 1, whereas the LED spot lights are mounted on a lite weight material such as aluminum or plastic that is made in a square or rectangular in shape.

5. The lighting device of claim 1, whereas the drone lighting bracket has mounting holes for mounting items.

6. The lighting device of claim 1, whereas the drone propellers act as a cooling device to keep LED spot lights from overheating.

7. The lighting device of claim 1, whereas the drone body has a mount for mounting lights or hanging lights from the bottom of the drone said tethers.

8. The lighting device of claim 1, whereas the drone power has a power output connection for powering other drone units;

9. The lighting device of claim 1, whereas the drone has a mounting bracket for mounting LED lights strips as a display light.

10. The lighting device of claim 1, whereas the drone is control by a flight controller, which is a remote controller to activate the drone,

11. The lighting device of claim 1, whereas a remote controller switch for turning on power for drone spotlight and voltage reducer;

12. The lighting device of claim 11, wherein the auxiliary battery or generator supplies continuous operating power to the drone and LED light for an extended length of time.

13. The lighting device of claim 12, An lighting device for a drone body, a microcontroller; a wireless receiver; whereby the LED lights strip maybe program to display image and color light show;

14. The lighting device of claim 13, Whereas by mounting Solar cell instead of LED spot lights in the place of the light mounting area the drone will maintain a much longer flight time.

15. The lighting device of claim 14, whereas the longer battery or generator life lasting for hours, on a drone or a quadcopter;

16. The lighting device of claim 15, self-piloting once in the air, sensors can be mounted on all sides of the drone to keep it safe by avoiding obstacles; a smartphone connected to the controller using an app.

18. The lighting device of claim 16, wherein the drone has a smartphone connected to the controller using an app, remote for changing the colors of the LED light strip.

19. The lighting device of claim 18, wherein the drone is wire and wirelessly connected to a flight controller images to activate display LED.

20. The lighting device of claim 19, wherein the battery or generator and solar panels for continuous powering and flight time in the air, also having optional sensors and controls.
